(19) United States
(12) Patent Application Publication
(10) Pub. No.: US 2006/0045004 A1
(43) Pub. Date: Mar. 2, 2006

(54) Method for diverting data packets when local link failures are identified

(76) Inventors: Joachim Charzinski, Munchen (DE); Michael Menth, Oellingen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/536,063

(22) PCT Filed: Nov. 27, 2003
(86) PCT No.: PCT/EP03/13380

§ 371 Date: May 24, 2005

(30) Foreign Application Priority Data
Nov. 29, 2002 (EP) 02026674.8

(51) Int. Cl. H04J 3/14; H04J 1/16

(52) U.S. Cl. 370/216; 370/242

(57) ABSTRACT

According to said method, routing information or a list of routing information is inserted or modified in the packet header of data packets, in response to a malfunction of the packet network, in order to avoid defective nodes or links. The data packets with modified headers are routed using the inserted routing information to avoid the network node that is not available. The routing information inserted in the packet header can be determined via the packet network with the aid of topological information. The invention allows a rapid response to malfunctions. Packet losses and delays in data transmission can thus be avoided immediately after the determination of the malfunction by routers adjoining the malfunction area, whereas in conventional packet networks, a problem-free data transmission can only be restored after the convergence of the modified topological information in the packet network.

### CROSS REFERENCE TO RELATED APPLICATIONS

This application is the US National Stage of International Application No. PCT/EP2003/013380, filed Nov. 27, 2003 and claims the benefit thereof. The International Application claims the benefits of European application No. 02026674.8 EP filed Nov. 29, 2002, both of the applications are incorporated by reference herein in their entirety.

### FIELD OF INVENTION

The invention relates to a method, a network node, and a central control node wherein a data packet transmitted over at least one section of a packet network is diverted on account of a malfunction.

### BACKGROUND OF INVENTION

The further development of packet networks, in terms particularly of the quality features associated with data packet transmission, is currently a focal area of activity for network specialists, switching engineers, and internet experts. Major importance is here attached to implementing quality features for realtime traffic over packet networks. For a service involving realtime data transmission, for example telephony or video on demand, packet networks employed therefore have to satisfy stringent criteria in terms of quality-of-service features such as duration of packet transmission, maximum packet delay, and packet loss rate in order to ensure the necessary service quality.

Forwarding of the packets from node to node—generally referred to in the relevant technical literature as “routing”—is pivotal to the reliability of packet transmission over packet networks. Conventional packet networks do not ensure compliance with any quality criteria. For example, present-day data traffic over the internet is as a rule routed on the best-effort principle, meaning that data packets are transmitted as efficiently as possible but with no assurance of meeting quality criteria. Data traffic over conventional packet networks is consequently prone to wide variations due, for instance, to bottlenecks, overloading, or malfunctions. Modern developments are aimed at improving data traffic reliability. A current approach to data transmission over the internet is what is termed the MPLS (Multiprotocol Label Switching) method, within the scope of which end-to-end connections are established through the packet network (the term “paths” is usually employed in this regard). Although a path-based distribution of data traffic allows better control of the volume of traffic routed over the packet network, this method involves substantially greater complexity.

Alongside overload prevention, the network's response to malfunctions, for example to the outage of a section of the connection (generally referred to in the relevant technical literature as a “link”) or a router or, as the case may be, a node, is one of the decisive factors in determining whether quality-of-service features can be maintained under realtime conditions, especially with regard to data traffic. Two routing algorithms, namely Distance Vector Routing and Link State Routing, are predominantly employed in the globally most widely used packet networks, what are termed IP networks, for routing within domains or, as the case may be, within autonomous systems (AS). In the case of Distance Vector Routing, the distance is minimized for the respective destination in terms of a metric. The routing table then contains the next station or, as the case may be, hop in terms of the minimum distance to the respective destination. A router employs the distance information of its adjacent routers to calculate the distance. Link State Routing is based on the propagation or, as the case may be, distribution of topology information or, as the case may be, distance information by means of what are termed link state packets in the entire network or, as the case may be, entire autonomous system. When faults occur, for example a node or link outage, there will in the case of both methods be an inconsistency in the routing tables or routing information kept by the routers. Said inconsistency will be gradually eliminated within the scope of topology information propagation. The term employed here is “routing information convergence”. Networks converged in terms of routing information will be free of inconsistencies and have concluded their response to the malfunction. Data transmission will nonetheless be impaired while the network is undergoing convergence, and that generally results in reduced quality. Fast network convergence is therefore decisive in determining the efficiency of a routing algorithm. Owing to its faster convergence, the Link State algorithm is today generally preferred to Distance Vector Routing.

### SUMMARY OF INVENTION

The object of the invention is to improve the response of packet networks to malfunctions.

Said object is achieved by means of the features of the claims.

According to the invention a network node in a packet network ascertains that a second network node is not accessible. Said second network node has sustained an outage, say, or the link leading to said second network node has malfunctioned. Routing information is inserted or changed by the network node in the packet header of a data packet that was originally to be routed via the no longer accessible second network node. The data packet will be forwarded in accordance with the inserted or, as the case may be, changed routing information in such a way that the path it takes will not include the faulty second network node.

In terms, for instance, of the routing specifications kept for the data packet by the first network node, the faulty second network node is the next hop, which is to say the next station or, as the case may be, next node on the data packet's path through the packet network. The inserted routing information, consisting for instance of the address of a network node, will then be used for routing that avoids the malfunctioning second network node. The routing information can for example reference an alternative next hop or a third node to which data packets are routed via another next hop that is not faulty. As a result of explicit referencing of the third node this will then be situated along the path via which the data packet is routed to its destination. Said third node is specified by, for instance, a boundary node of a routing domain or, as the case may be, of an autonomous system.

In the case of various routing protocols such as OSPF (Open Shortest Path First) the first network node does not possess any detailed information about the routing tables of the network nodes via which the data packet will be routed in accordance with the inserted routing information. The method according to the invention will nonetheless preclude any network nodes downstream of the first network node from routing the data packet to the faulty node provided the downstream network nodes that would topologically be candidates for routing to the faulty network node support the method according to the invention and have been informed of the non-accessibility of the faulty node or, as the case may be, of the link outage. Support for the method by the nodes coming after is not necessary in the case of the development described below in which topology information of the packet network is utilized.

The development of the invention provides for the provisioning in the network node of routing information that is based on information about the topology of the packet network and through the insertion of which it will be ensured that no routing to the faulty network node will be occasioned by nodes that are downstream of the network node, either. The routing information based on the network topology (reference will be made in the following to a “list of routing information”) can consist of one or more node addresses for further routing. As a result of routing using said addresses, a path will be specified which, within the scope of the routing protocol employed, will not be able to pass through the faulty node. In modern networks topology information is frequently routinely exchanged between the network nodes at predefined intervals. As an instance of this, Link State routing provides for the periodic exchange of what are termed Link State Advertisements (LSA) through which topology information is propagated or, as the case may be, disseminated in the network. A similar role is played in the case of Distance Vector Routing protocols by the exchange of “Distance Vectors” through which updating of the topology information kept by the network nodes is achieved. The routing information that is to be inserted into the data packet by the network nodes can be selected with the aid of topology information in such a way that the data packet will be routed along a path that does not pass through the faulty network node, with succeeding nodes only supporting the method according to the invention if routing is carried out using the inserted routing information. The method can be expanded to include the outage of a plurality of network nodes, with the routing information requiring to be inserted then being determined in such a way that none of the faulty nodes will be situated along the path taken by the data packet. A further variant provides for using the routing information to specify a path that avoids the vicinity of the faulty node, the assumption here being that the malfunction also affects the faulty node's vicinity.

The advantage of the invention lies in permitting a fast response to malfunctions. Convergence as regards the topology information propagated in the network ceases to be decisive for problem-free transmission of data packets within the network. It will be of practical advantage to limit the length of time for applying the method according to the invention in accordance with the convergence of the topology information within the packet network. The faulty node(s) will have been removed from the routing tables of the network nodes on restoration of convergence so that the response, according to the invention, of the network to malfunctions can be deactivated. The method is flexible in terms of the network's response to faults. As an instance of this, it will be possible to respond to the non-accessibility of one or more nodes and even to the outage or, as the case may be, non-accessibility of entire network sectors. The method according to the invention is not restricted to specific protocols. Present-day packet networks as a rule provide for a structure that distinguishes between routing within what are termed domains or, as the case may be, autonomous systems and routing between the various domains or, as the case may be, autonomous systems. The relevant technical literature employs the terms “intradomain routing” and “interdomain routing” in this connection. The invention can be applied in connection both with any intradomain routing protocols such as, for example, OSPF (Open Shortest Path First), IS-IS (Intermediate System to Intermediate System), NLSP (NetWare Link Service Protocol), and PNNI (Private Network-to-Network Interface) for Link State Routing or RIP (Routing Information Protocol), and RTMP (Routing Table Maintenance Protocol) for Distance Vector Routing, and with interdomain routing, for example in conjunction with the EGP (Exterior Gateway Protocol) or BGT (Border Gateway Protocol) protocol (EGP is used also as a generic term for interdomain protocols).

The process of calculating or, as the case may be, determining routing information for the outage of one or more network nodes can be triggered for example at the network node through notification of the outage or, as the case may be, malfunction. Routing information for avoiding non-accessible network nodes can alternatively be calculated in advance and made available in routing tables of the network node. For example, the network node has a routing table which, besides a next hop for forwarding a data packet to a destination specified in the packet header of the data packet, contains a further entry with routing information or, as the case may be, routing addresses. If the next hop is not accessible, the routing addresses of the further entry in the routing table will be inserted into the packet header of the data packet and routing based on said inserted addresses will then avoid the faulty node. The routing information for circumventing non-accessible next hops will not then have to be calculated when the malfunction is reported. The entries in the routing tables can be determined using a list according to the invention of routing information or immediately after the routing tables have been produced. The calculating or, as the case may be, determining process can take place in the network node itself or at a central location or, as the case may be, in a central control node. If the calculating process takes place at a central location it is necessary for the calculation information to be propagated with the aid of a protocol to the relevant network nodes. This disadvantage of additional traffic is countered by the advantage of less computing overhead and reduced resource requirements in the network nodes.

An advantageous development in determining routing information for the purpose of routing via a path that avoids a non-accessible node is the complementary application of the insertion according to the invention of routing information into the packet header and forwarding of the unchanged data packet to an alternative next hop. If it is ascertained while the routing information for routing according to the invention is being determined that forwarding from the network node to another next hop will suffice to avoid routing via the faulty network node, then it will not be necessary to insert the routing information into the packet header. For example, alongside a list of routing information according to the invention, routing to an alternative next hop can, without modifying the packet header, be provided in a routing table by means of a further entry indicating the applicable treatment in the event of malfunctions, if that will suffice to avoid the faulty network node.

The following is a further development covering a special case: The list of routing information can be determined by calculating an alternative path to the destination, which path avoids the faulty nodes. In special cases it is not possible to calculate an alternative path of this type. As an instance of this, an intradomain routing protocol can provide, on the basis of the existing non-converged topology information, for all data traffic to a specific destination address to exit the network or, as the case may be, domain via the same fixed boundary node. In the event of an outage of said fixed boundary node, it will not be possible to calculate an alternative path to the data packet's destination on the basis of the existing topology information if convergence of the topology information within the network has not occurred following the boundary node outage. A provision according to the development is in this case to dispense with determining an alternative path and instead to determine a path in accordance with the boundary node outage applying the proviso that it will avoid the faulty node. For example, routing would then, based on the routing information or, as the case may be, list of routing information according to the invention, provide for forwarding of the data packet to a network node that has not failed. If the node is a boundary node, the data packet can then be forwarded to the destination (located in a different network) using an interdomain protocol. Following convergence of the topology information, a failed boundary node would then, of course, no longer be provided for routing to a destination outside the network and the method according to the invention would no longer need to be applied.

A provision of another advantageous development is for network nodes coming after the first network node to extract the routing information or, as the case may be, list of routing information in order to use it for routing data packets having the same destination but a different origin address. The network node coming after will be prompted, for example by the routing information inserted into the packet header, to forward the data packet to a next hop different from that provided for in the locally existing routing table. From the viewpoint of the network node coming after, there is a fault for which countermeasures have been taken to the effect that the data packet having the modified packet header is being forwarded to another next hop. Consequently, data packets having the same destination (which is to say that, as a rule, the destination address is in the same network or that the destination network is the same) must be forwarded in a manner different from that provided for in the local routing table, as must also the data packet modified in the packet header, in order to avoid the non-accessible node. The node coming after can use the routing information extracted from the packet header for routing data packets having the same destination. In the case of data packets that have the same destination and which have not already been modified for the purpose of avoiding the faulty node, the extracted routing information or, as the case may be, a part thereof affecting nodes coming after is, where applicable, inserted into the packet header in order to implement routing aimed at avoiding the non-accessible node. The node coming after is thereby spared having to calculate an alternative path from topology information for data packets having the same destination.

A further special case provides as part of the fault-avoiding process for a data packet to be sent back over the link via which it reached the network nodes. There are routing methods which, as part of the process of avoiding loops or delays, for instance, do not allow data packets to be sent back. According to the invention it can be provided for the restraint on sending back to be lifted in such a case.

A final special case provides for routing into a non-homogeneous network consisting of routers having resources for the method according to the invention and routers that do not support the method according to the invention. The limitation of only a part of the routers having the functionality for the method according to the invention can then be taken into consideration in determining the routing information for insertion into the packet header of the data packet in order thereby to enable the method according to the invention to be used also in non-homogeneous networks.

### BRIEF DESCRIPTION OF THE DRAWINGS

The invention is explained in more detail below on the basis of an exemplary embodiment with reference to figures, in which:

FIG. 1: shows a section of a packet network formed using routers and links

FIG. 2: shows an entry in a routing table indicating a response according to the invention to a node outage

FIG. 3: shows the indexing of lists for alternative routing as part of a response according to the invention to faults in accordance with the egress nodes of the network

FIG. 4: shows how indexing as per FIG. 3 is used for the routing entry according to FIG. 2

### DETAILED DESCRIPTION OF INVENTION

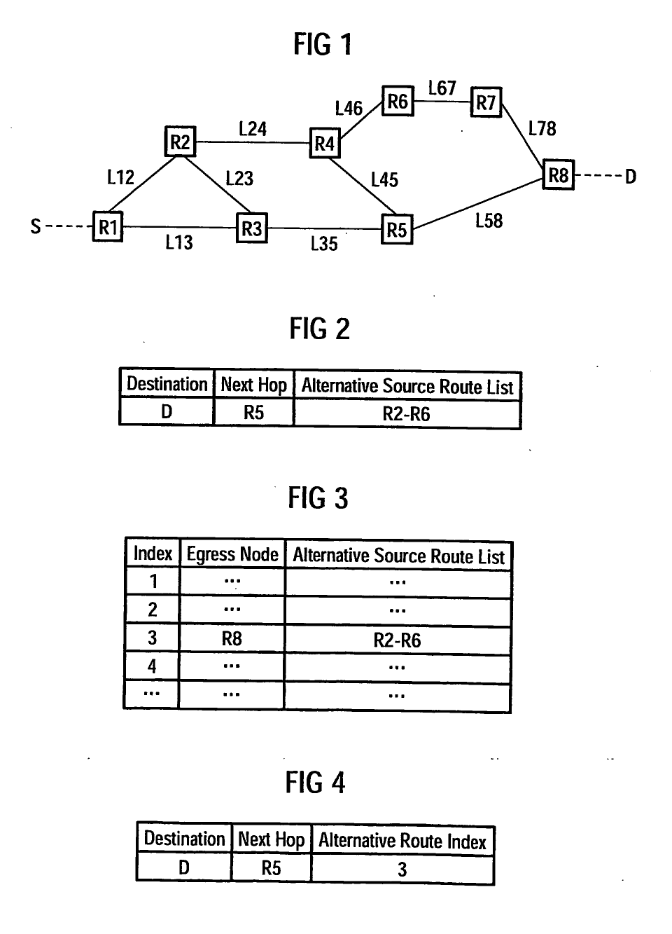

FIG. 1 illustrates a section of a packet network on which are shown 8 routers or, as the case may be, nodes R1, . . . , R8 and links L12, . . . , L78 linking said routers. It is assumed for the purposes of the exemplary embodiment that the packet network is an IP (Internet Protocol) network. Considered therein are packets sent from a source node S and a destination node D, both of which can be located outside the packet network. Said packets are intended in normal conditions (which is to say when there are no link or node outages) to take the path S . . . R1-L13-R3-L35-R5-L58-R8 . . . D. It is assumed in the following that link L35 in said path has failed due to a fault. With classical IP routing the packets between S and D would then continue to be lost until, with the outage having been identified and the outage report distributed to all nodes via a routing protocol, the relevant nodes have recalculated new routing tables containing a valid path between S and D (referred to above as convergence of the network in terms of the propagated topology information).

It is assumed that the routers R1, . . . , R8 support the IP “loose source routing” option. The node identifying the outage—so in this case R3—will then expand the IP header of all packets that are to be sent to D to include a field (source routing option) in which it is specified that said packets are to be forwarded via the nodes R2 and R4. R3 selects the node R2 as the intermediate node because the direct path to R4 would possibly pass through L35. R4 is specified as an additional intermediate node so that router R2 will not attempt to forward packets to D via the link L23-R3-L35- . . . Router R2 thus does not need any information about the outage of link L35. The method will function independently of whether or not router R2 has received an update to its topology information that includes notification of the link outage. Router R4 would therefore not need to be specified for further routing if router R1 could assume that router R2 will route all traffic for the destination D via router R4. Information of said type is, however, generally not provided in the case of IP networks. Although with standard IP routing according to OSPF or IS-IS the network topology is known throughout the network, this does not apply to the routing tables of the individual nodes since the shortest-path routing algorithm employed is not deterministic and path selection will be dependent on implementation if the paths are of equal length (equal in cost terms).

According to a development of the method a node that identifies a link outage will assume that the node behind it will have failed also. The list of intermediate nodes will then be selected to avoid said node. In the present example from FIG. 1, router R3 would according to said development enter the intermediate nodes R2 and R6 (or R2 and R7) in the source route list into the packet header of affected packets.

For the method described with reference to FIG. 1, for each entry in its routing table node R1 keeps a list of the intermediate nodes via which the destination can still be reached if the next link or, as the case may be, next node fails. An algorithm enabling an alternative path to be determined is described below. The algorithm runs locally in a node and uses only the information that is available to said node (for example topology information conveyed by way of Link States Agreements):
For each entry D[i] in the routing table (i=1, 2, . . . r), where r=number of entries in the routing table:
Assumption: The succeeding node (next hop) has failed
Under this condition, look for the shortest path to the destination D and enter all m nodes along said path (within the network under consideration) one after the other in a node list E.
Add a final entry to the list E[m+1]=D[i]
For each entry E[j] in said node list, from the bottom, beginning with the last entry but one, which is to say j=m−1, m−2, . . . , 2, 1 (where m is the number of nodes along the path)
Check whether in the original network (no outage) the shortest path from E[j] to E[j+2] passes reliably via E[j+1].
If so: Delete E[j+1] from the list, which is to say the entry is cancelled and the list accordingly shortened by one entry. The entry that was previously E[j+2] will therefore now occupy position j+1.
If not: Retain E[j+1] in the list
Check whether in the local routing table the entry for the destination E[2] gives node E[1] as the next hop.
If so: Remove E[1] from the list (which is to say E[2] will become the new E[1], etc., see above)
If not: Retain E[1] in the list.
Note the nodes remaining in the list as a list of “loose source routing” nodes in a field assigned to D[i] in the routing table

“Reliably” here signifies that the possible variants of the shortest-path algorithm will be taken into consideration in the other network nodes. That means that if there are several shortest paths from E[j] to E[j+2] and not all of them contain the node E[j+1], then E[j+1] will be left in the list.

The effect of the algorithm is to reduce the number of entries in the list to the minimum necessary to avoid the faulty link.

The contents of the entry for D in the routing table of node R3 could, according to this algorithm, be those shown in FIG. 2. The routing table provides the next hop R5 for the destination D. A list containing the entries R2 and R6 is provided for the event that R5 is not accessible. R4 is not included in the list because it is assumed that, within the scope of a least-cost metric, router R4 will always route certain packets intended for router R6 directly to router R6. The addresses of R2 and R6 will, according to the invention, be inserted into the packet header within the scope of the source route option.

According to a development, an egress node or, as the case may be, boundary node of the network domain can serve instead of the destination node D as the destination of the alternative path requiring to be determined. The algorithm can then be employed in the following variant application:

For each entry D[i] in the routing table:
Locate the egress node AN of the network area under consideration along the path to D[i]. Assumption: Proceeding from a network area, the traffic to a destination network will always be routed via a well-defined egress node.
Enter that node in an egress node table if not already included. The index of the entry is k, so the entry itself is A[k].
Enter the index k in a corresponding field in the routing table for entry D[i].
For all egress nodes A[k], k=1, 2, . . . , number of egress nodes in the network area under consideration:
Run through the algorithm from the top, with the list of diversion nodes being kept in the list A[k] and not in the routing table.

The remaining steps are analogous to the version of the algorithm described first.

FIG. 3 indicates lists of alternative paths for each egress node in the network domain under consideration. The lists have been indexed for more efficient referencing. The third entry corresponds to the example considered using FIG. 1. It is here assumed that router R8 is a boundary node.

FIG. 4 shows the routing table entry corresponding to FIG. 2. Use of the index for referencing the alternative path is an economic solution insofar as the same alternative path is generally used for a plurality of end addresses D (or, as the case may be, the packets are routed via the same egress node). Repeated specifying of the entire list for each associated end address is avoided.

1-17. (canceled)

18. A method for diverting data packets due to a malfunction, the data packets transmitted over at least part of a packet network formed from a plurality of network nodes, comprising:
identifying, by a first network node, an inaccessibility of a second network node;
identifying, by routing information of the first network node, a data packet to be forwarded to the second network node when the second network node is accessible, the data packet having a packet header;
modifying the packet header having a routing item in order to divert the data packet from the second network node when the second network node is inaccessible, the modification selected from the group consisting of inserting the routing item and changing the routing item; and
forwarding the modified data packet from the first network node in accordance with the modified header.

19. The method according to claim 18, wherein the malfunction is selected from the group consisting of a link outage and a node outage.

20. The method according to claim 18, wherein the second network node is a next hop of the data packet from the first network node when the second network node is accessible.

21. The method according to claim 19, wherein the first network node includes a list of routing information assigned to the next hop of the data packet.

22. The method according to claim 18, wherein the routing item includes node address information.

23. The method according to claim 18, wherein the routing information is determined via a topology information about the packet network in order to avoid the inaccessible second network node.

24. The method according to claim 18, wherein the routing information is determined by calculating a path for routing the data packet in order to avoid the inaccessible second network node.

25. The method according to claim 18, wherein the first network node includes a routing table for forwarding a data packet to a destination address via a next hop, the routing information is determined for at least a part of the destination address in the routing table, and if the next hop is inaccessible in the case of the data packet having the destination address provided by the routing table where the inaccessible next hop being the next hop, then the corresponding routing information is used to modify the packet header.

26. The method according to claim 25, further comprising including an address referencing a further next hop in the routing information, and forwarding the packet without modification to the packet header to the specified further next hop if the next hop is inaccessible.

27. The method according to claim 25, wherein the routing information is determined via a topology information in a first network node.

28. The method according to claim 25, wherein the routing information is determined via a topology information in a central control node and conveyed to the first network node.

29. The method according to claim 18, wherein the packet network is based on an Internet Protocol and the routing item is inserted into an Internet Protocol header of the data packet as address information in terms of a loose source routing.

30. The method according to claim 25, wherein the routing information is determined via a topology information about the packet network in order to avoid a plurality of inaccessible network nodes.

31. The method according to claim 19, wherein a time limit for diverting packets following the malfunction is applied, the time limit determined by the time that convergence of the topology information of the plurality of the network nodes in the packet network takes place.

32. The method according to claim 18, wherein the routing item is extracted from the modified header by a third network node for use by the third network node to route a further data packet with the purpose of avoiding a inaccessible network node.

33. The method according to claim 18, wherein at least part of the nodes in the packet network have resources for implementing the method.

34. A network node in a packet network, comprising
a received data packet having a packet header including a routing item, the routing item indicating a first address of an inaccessible network node address;
a modifier for modifying the routing item to a second address of an accessible network node, the modification selected from the group comprising changing the routing item and inserting a new routing item; and
a sending mechanism for sending the modified data packet in accordance with the modified routing item.

35. The network node according to claim 34, further comprising a routing table for forwarding the data packet to a destination address via a next hop, the destination address include a routing information for avoiding the respective next hop.

36. A central control node in a packet network from a plurality of network nodes, comprising:
a routing information determined via a network topology information adapted to avoid routing to an inaccessible node routing information; and
a transfer mechanism to convey the routing information to a network node.
